(19) United States
(12) Patent Application Publication
(10) Pub. No.: US 2013/0036259 A1
(43) Pub. Date: Feb. 7, 2013

(54) SOLID STATE DRIVE AND DATA STORING METHOD THEREOF

(71) Applicant: Chih-Wei Huang, Hsinchu (TW)

(72) Inventor: Chih-Wei Huang, Hsinchu (TW)

(73) Assignee: LITE-ON IT CORPORATION, Taipei (TW)

(21) Appl. No.: 13/412,781

(22) Filed: Mar. 6, 2012

(30) Foreign Application Priority Data
Aug. 1, 2011 (CN) 201110217300.1

(51) Int. Cl. G06F 12/00

(52) U.S. Cl. 711/103; 711/E12.008

(57) ABSTRACT

A solid state drive includes a plurality of dies. The dies are divided into first-portion dies and second-portion dies. The first-portion dies are located at a user area. The second-portion dies are located at a reserved area. The solid state drive is in communication with a host. The data storing method of the solid state drive includes the following steps. Firstly, if the host generates a plurality of write data to the solid state drive, the plurality of write data are stored into the reserved area. If there is not accessing action between the host and the solid state drive and if the write data are in the reserved area, the write data are stored into the user area. Afterwards, error correction codes corresponding to the write data in the user area are calculated and stored into the reserved area.

This application claims the benefit of People's Republic of China Application Serial No. 201110217300.1, filed Aug. 1, 2011, the subject matter of which is incorporated herein by reference.

### FIELD OF THE INVENTION

The present invention relates to a storage device and a data storing method thereof, and more particularly to a solid state drive and a data storing method thereof.

### BACKGROUND OF THE INVENTION

As is well known, a solid state drive (SSD) is a data storage device that uses a NAND-based flash memory to store data. The NAND-based flash memory is a non-volatile memory. After data are written to the flash memory, if no power is supplied to the flash memory, the data are still retained in the flash memory.

FIG. 1 is a schematic circuit diagram illustrating a typical solid state drive. As shown in FIG. 1, the solid state drive 100 comprises a plurality of dies 11˜84 and a controlling unit 92. The controlling unit 92 is connected to a host (not shown) through an external bus (e.g. a SATA bus).

These dies 11˜84 are arranged in a 4×8 array. The four rows of the 4×8 array are connected to the select signals CE0˜CE3, respectively. The eight dies of each row of the 4×8 array are connected to the I/O buses IO0˜IO7, respectively. By means of the select signals CE0˜CE3 and the I/O buses IO0˜IO7, the controlling unit 92 can access data to any of the dies 11˜84. The storage capacity of each die is 2G˜16G bytes or higher. In general, the dies of the solid state drive may be arranged in an m×n array. If we increase m and/or n, we can get more storage capacity. That is, the arrangement of the dies is not limited to that of FIG. 1.

Generally, each die comprises a plurality of blocks. Each block comprises a plurality of pages. During the writing operation is performed, at least one page is written at a time.

Generally, during the operations of the NAND-based flash memory, the data storage blocks of the NAND-based flash memory are possibly damaged. For maintaining the data accuracy, a DIE RAID (die redundant array of independent disks) technique for a solid state drive is disclosed. According to the DIE RAID technique, an error correction code (ECC) is recorded into the die. In a case of data corruption, the parity data generated by the error correction code may be employed to correct the data.

FIG. 2 is a schematic circuit diagram illustrating a solid state drive using a DIE RAID technique according to prior art. As shown in FIG. 2, the controlling unit 92 of the solid state drive 100 comprises an error correction unit 93. The controlling unit 92 is used for managing all of the dies 11˜84 and dividing these dies into two portions. The first-portion dies are located at a user area 94. The second-portion dies are located at a reserved area 96.

In a case that the host generates write data to the solid state drive 100, the error correction codes (e.g. parity data) corresponding to the write data are calculated by the error correction unit 93 of the controlling unit 92. In addition, the write data are stored in the dies located in the user area 94, and the error correction codes are written into the dies of the reserved area 96. If any data at a specified position of the user area 94 is erroneous, the error data may be corrected according to the corresponding error correction codes in the reserved area 96 and the valid data at the specified position. In such way, the data accuracy will be enhanced.

FIG. 3 is a flowchart illustrating a data storing method using a DIE RAID technique according to prior art. After the solid state drive 100 is activated, the solid state drive 100 waits for the write command from the host. If the write data are generated from the host to the solid state drive 100 (Step S210), the error correction codes corresponding to the write data are calculated by the error correction unit 93 of the controlling unit 92, and the write data and the error correction codes are respectively written into the user area 94 and the reserved area 96 (Step S220).

The controlling unit 92 needs to store both the write data into the user area 94 and the error correction codes into the reserved area 96. However, the controlling unit 92 wouldn't write the error correction codes into the reserved area 96 until the error correction codes corresponding to the write data are calculated by the error correction unit 93. The more write data comes, the slower the system write through put performance goes. That is, if the conventional data storing method is used for processing a great number of write data, the writing speed of the solid state drive 100 is adversely affected.

### SUMMARY OF THE INVENTION

Therefore, the present invention relates to a data storing method for a solid state drive in order to increase the speed of writing data and maintain the data accuracy.

The first embodiment of the present invention provides a data storing method for a solid state drive. The solid state drive includes a plurality of dies. The dies are divided into first-portion dies and second-portion dies. The first-portion dies are located at a user area. The second-portion dies are located at a reserved area. The solid state drive is in communication with a host. The data storing method includes the following steps. Firstly, if the host generates a plurality of write data to the solid state drive, the write data are stored into the reserved area. If there is no accessing action between the host and the solid state drive, a judging step is performed to judge whether the plurality of write data are in the reserved area. The judging step will check “Is there any write data in the reserved area?” If yes, the write data are stored into the user area. Afterwards, error correction codes corresponding to the write data in the user area are calculated and stored into the reserved area.

The second embodiment of the present invention provides a data storing method for a solid state drive. The solid state drive includes a plurality of dies. The dies are divided into first-portion dies and second-portion dies. The first-portion dies are located at a user area. The second-portion dies are located at a reserved area. The solid state drive is in communication with a host. The data storing method includes the following steps. Firstly, if the host generates a plurality of write data to the solid state drive, the write data are stored into the user area and the reserved area. If there is no accessing action between the host and the solid state drive, a judging step is performed to judge whether a portion of the write data are in the reserved area. If a portion of the write data is in the reserved area, storing the portion of the write data into the user area. Afterwards, error correction codes corresponding to the write data in the user area are calculated and stored into the reserved area.

The third embodiment of the present invention provides a data storing method for a solid state drive. The solid state drive includes a plurality of dies. The dies are divided into first-portion dies and second-portion dies. The first-portion dies are located at a user area. The second-portion dies are located at a reserved area. The solid state drive is in communication with a host. The data storing method includes the following steps. Firstly, if the host generates a plurality of write data to the solid state drive, the write data are stored into the user area. If there is no accessing action between the host and the solid state drive, error correction codes corresponding to the write data in the user area are calculated and stored into the reserved area.

The fourth embodiment of the present invention provides a solid state drive. The solid state drive is in communication with a host and includes a controlling unit and a plurality of dies. The controlling unit is in communication with the host through a specified bus, wherein the controlling unit includes an error correction unit. The dies are connected with the controlling unit. Moreover, the dies are divided into first-portion dies and second-portion dies. The first-portion dies are located at a user area. The second-portion dies are located at a reserved area. If the host generates a plurality of write data to the solid state drive, the write data are stored into the user area or the reserved area by the controlling unit. If there is no accessing action between the host and the solid state drive, error correction codes corresponding to the write data are calculated by the controlling unit and stored into the reserved area.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (Prior art) is a schematic circuit diagram illustrating a typical solid state drive;

FIG. 2 (Prior art) is a schematic circuit diagram illustrating a solid state drive using a DIE RAID technique according to prior art;

FIG. 3 (Prior art) is a flowchart illustrating a data storing method using a DIE RAID technique according to prior art;

FIG. 4 is a schematic circuit diagram illustrating a solid state drive according to an embodiment of the present invention;

FIGS. 5A and 5B are flowcharts illustrating a data storing method using a DIE RAID technique according to the first embodiment of the present invention;

FIGS. 6A and 6B are flowcharts illustrating a data storing method using a DIE RAID technique according to the second embodiment of the present invention;

FIGS. 7A and 7B are flowcharts illustrating a data storing method using a DIE RAID technique according to the third embodiment of the present invention; and

FIGS. 8A˜8D schematically illustrate the process of storing the writing data into the solid state drive by the data storing method according to the second embodiment of present invention.

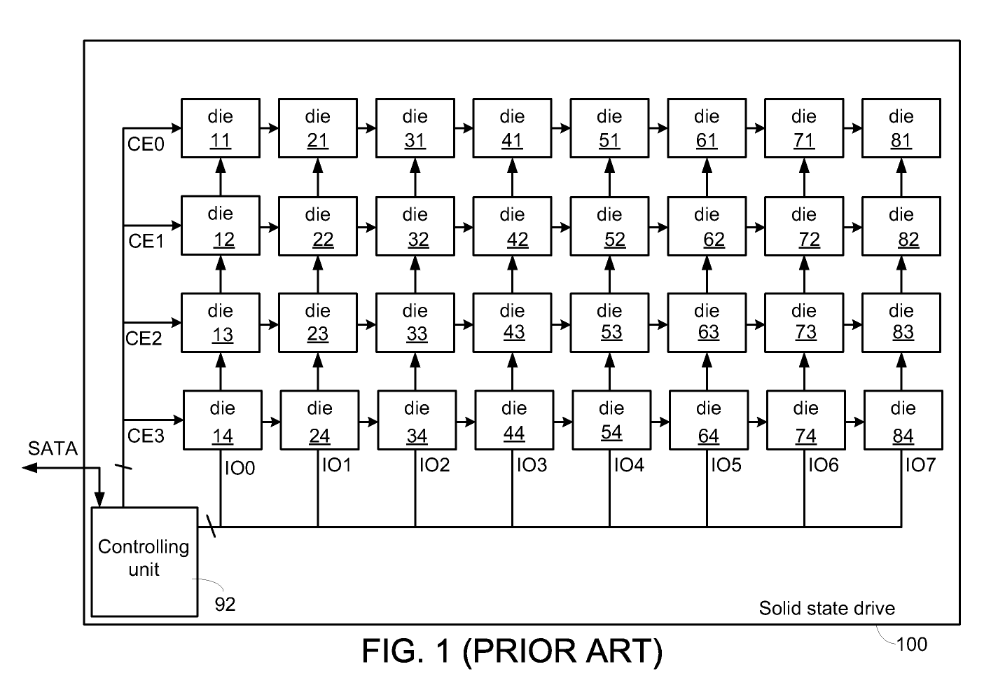

### DETAILED DESCRIPTION OF PREFERRED EMBODIMENTS

Generally, in a case that the amount of the write data from the host is too huge, the writing speed of the solid state drive is obviously decreased. In accordance with the present invention, during the process of storing the write data, the write data are stored into the dies of the solid state drive at a fastest speed while the error correction unit is disabled. That is, once the write data from the host are received by the solid state drive, the write data are stored into the user area, or the reserved area, or the user area and the reserved area. If there is not accessing action between the host and the solid state drive, the controlling unit performs a background operation. During the background operation is performed, the error correction codes corresponding to the write data are calculated by the error correction unit, and the storing positions of the write data and the error correction codes in the solid state drive will be re-distributed. That is, the write data are stored in the user area, and the error correction codes are stored in the reserved area. Consequently, the data storing method for a solid state drive according to the present invention can increase the speed of writing data and maintain the data accuracy

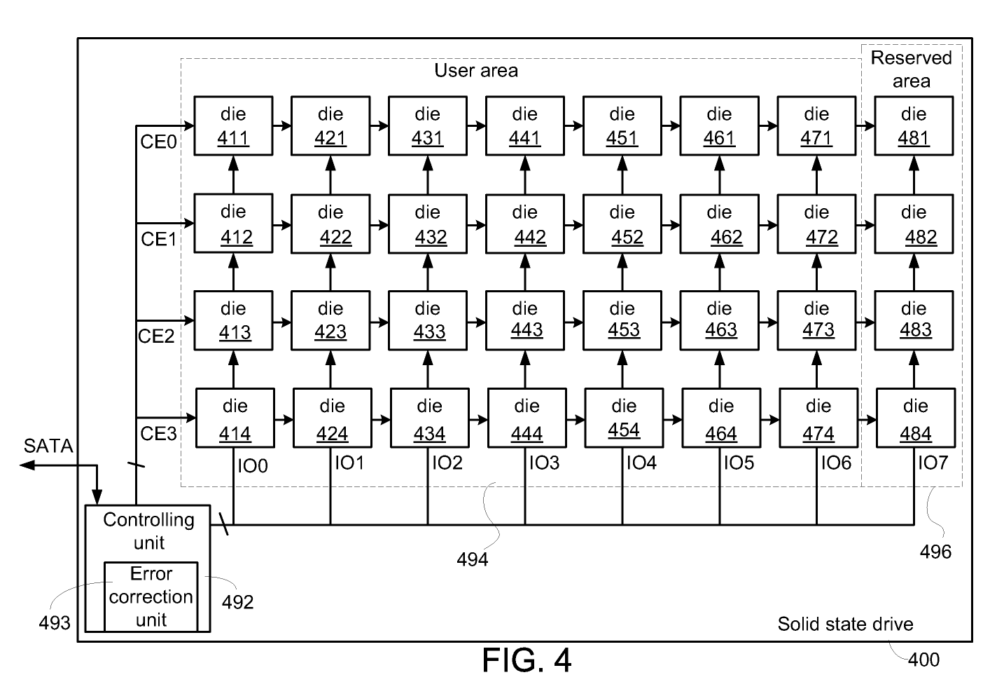

FIG. 4 is a schematic circuit diagram illustrating a solid state drive according to an embodiment of the present invention. As shown in FIG. 4, the solid state drive 400 comprises a plurality of dies 411˜484 and a controlling unit 492. The controlling unit 492 comprises an error correction unit 493. The controlling unit 492 is connected to a host (not shown) through an external bus (e.g. a SATA bus).

These dies 411˜484 are arranged in a 4×8 array. The four rows of the 4×8 array are connected to the select signals CE0˜CE3, respectively. The eight dies of each row of the 4×8 array are connected to the I/O buses IO0˜IO7, respectively. By means of the select signals CE0˜CE3 and the I/O buses IO0˜IO7, the controlling unit 492 can access data to any of the dies 411˜484. The storage capacity of each die is 2G˜16G bytes or higher. In a case that the solid state drive has more total storage capacity, the dies of the solid state drive may be arranged in an m×n array. That is, the arrangement of the dies is not limited to that of FIG. 4.

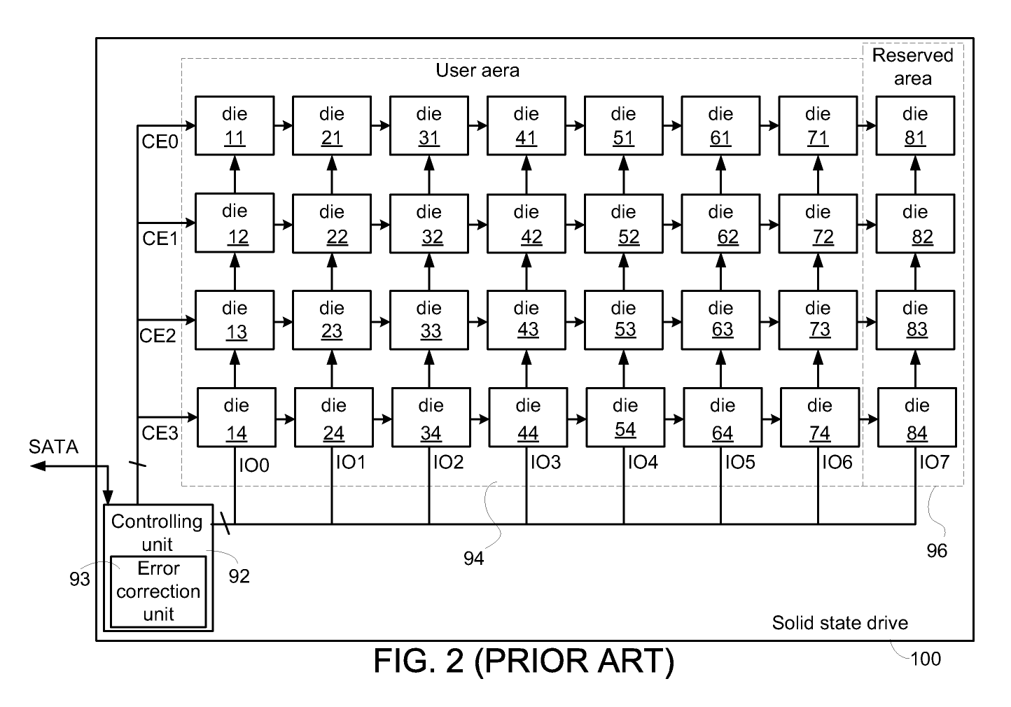

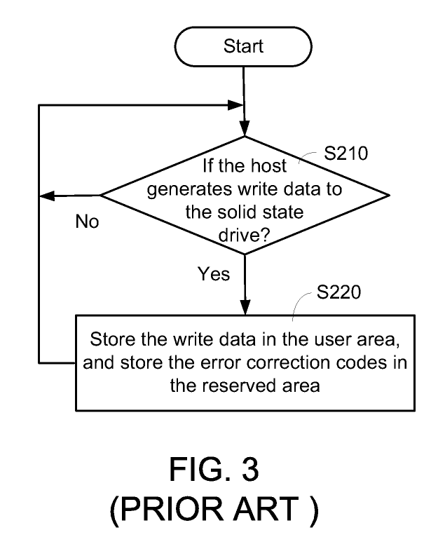

The controlling unit 492 is used for managing all of the dies 411˜484 and dividing these dies into two portions. The first-portion dies are located at a user area 494. The second-portion dies are located at a reserved area 496. In comparison with the solid state drive 100 of FIG. 2, the data storing method implemented by the controlling unit 492 of the solid state drive 400 is distinguished.

A data storing method according to a first embodiment of the present invention will be illustrated as follows. When a write data generated by the host is written into the solid state drive 400, the write data is directly written into the reserved area 496 by the controlling unit 492. Meanwhile, the error correction unit 493 is disabled. If there is not accessing action between the host and the solid state drive 400, the controlling unit 492 performs a background operation. During the background operation is performed, the write data in the reserved area 496 are moved to the user area 494. In addition, the error correction codes corresponding to the write data are calculated by the error correction unit 493 and written into the reserved area 496.

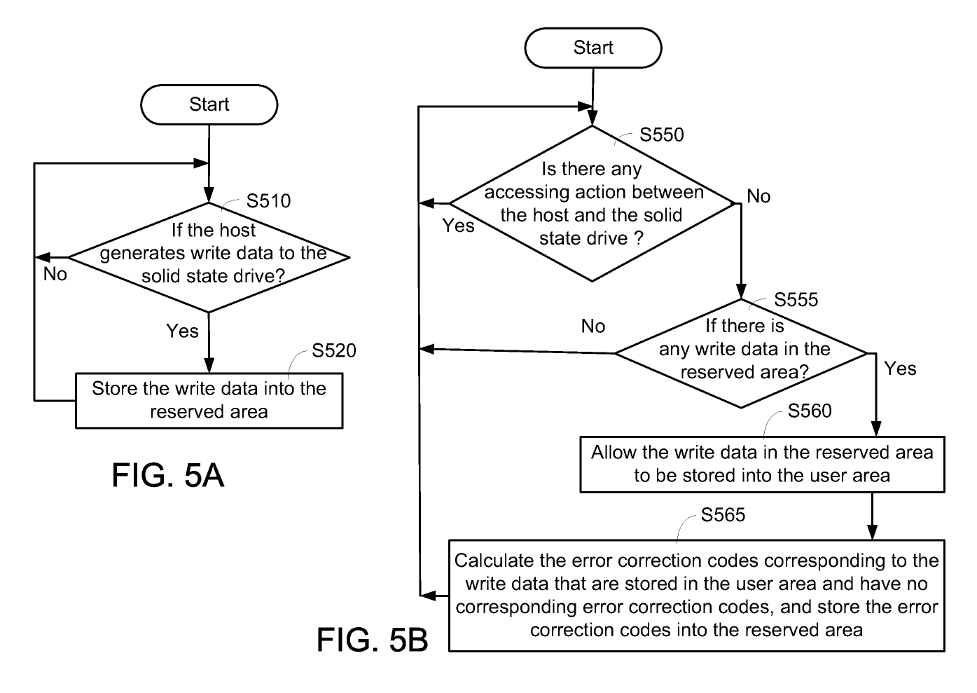

FIGS. 5A and 5B are flowcharts illustrating a data storing method using a DIE RAID technique according to the first embodiment of the present invention. Please refer to FIG. 5A. After the solid state drive 400 is activated, the solid state drive 400 continuously waits for the write command and the write data from the host. If the host generates write data to the solid state drive 400 (Step S510), the write data are stored into the reserved area 496 by the controlling unit 492 (Step S520).

Please refer to FIG. 5B, which illustrates a way of moving the write data when there is not accessing action between the host and the solid state drive 400. After the solid state drive 400 is activated, the controlling unit 492 will judge whether any accessing action between the host and the solid state drive 400 is done or not (Step S550). If the controlling unit 492 confirms that there is not accessing action between the host and the solid state drive 400, the controlling unit 492 will judge whether there is any write data in the reserved area 496 (Step S555).

If there is any write data in the reserved area 496, the solid state drive 400 starts to perform a background operation. Consequently, the write data in the reserved area 496 are stored into the user area 494 by the controlling unit 492 (Step S560). Then, the error correction codes corresponding to the write data that are stored in the user area 494 which has no corresponding error correction codes are calculated by the error correction unit 493, and then stored into the reserved area 496 (Step S565).

From the above discussions, if there is not accessing action between the host and the solid state drive 400, the controlling unit 492 will perform a background operation. During the background operation is performed, the storing positions of the write data and the error correction codes in the solid state drive 400 will be re-distributed. Under this circumstance, the performance of transmitting data between the host and the solid state drive 400 is not adversely affected.

Moreover, during the flowchart as shown in FIG. 5B is performed or after the flowchart as shown in FIG. 5B is completed, the write data in the reserved area 496 may be optionally deleted. Consequently, the writable capacity of the reserved area 496 will be increased.

In a case that the amount of the write data outputted from the host is huge, the write data may fail to be completely stored in the reserved area 496. For solving this problem, according to the second embodiment of the present invention, the write data are stored in both of the user data 494 and the reserved area 496 while the error correction unit 493 is disabled. If there is not accessing action between the host and the solid state drive 400, the controlling unit 492 will perform a background operation. Consequently, the write data in the reserved area 496 will be moved to the user area 494. In addition, the error correction codes corresponding to the write data are calculated by the error correction unit 493, and then written into the reserved area 496.

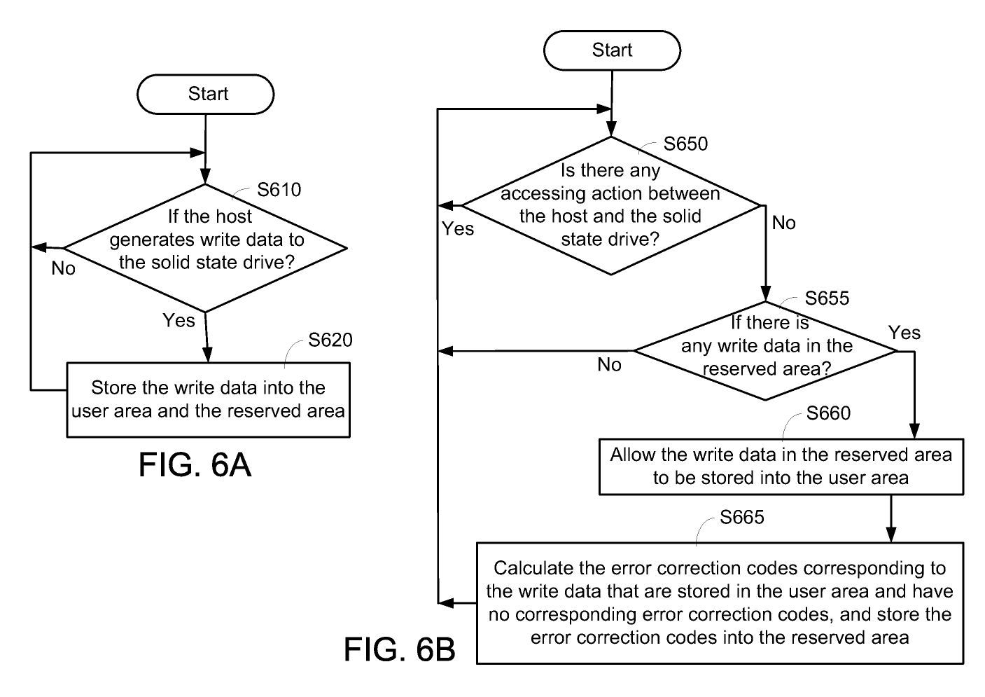

FIGS. 6A and 6B are flowcharts illustrating a data storing method using a DIE RAID technique according to the second embodiment of the present invention. Please refer to FIG. 6A. After the solid state drive 400 is activated, the solid state drive 400 continuously waits for the write command and the write data from the host. If the host generates write data to the solid state drive 400 (Step S610), the write data are stored into the user area 494 and the reserved area 496 by the controlling unit 492 (Step S620).

Please refer to FIG. 6B, which illustrates a way of moving the write data when there is not accessing action between the host and the solid state drive 400. After the solid state drive 400 is activated, the controlling unit 492 will judge whether any accessing action between the host and the solid state drive 400 is done or not (Step 6550). If the controlling unit 492 confirms that there is not accessing action between the host and the solid state drive 400, the controlling unit 492 will judge whether there is any write data in the reserved area 496 (Step S655).

If there is any write data in the reserved area 496, the solid state drive 400 starts to perform a background operation. Consequently, the write data in the reserved area 496 are stored into the user area 494 by the controlling unit 492 (Step S660). Then, the error correction codes corresponding to the write data that are stored in the user area 494 and have no corresponding error correction codes are calculated by the error correction unit 493, and then stored into the reserved area 496 (Step S665).

From the above discussion, if there is no accessing action between the host and the solid state drive 400, the controlling unit 492 will perform a background operation. During the background operation is performed, the storing positions of the write data and the error correction codes in the solid state drive 400 will be re-distributed. Under this circumstance, the performance of transmitting data between the host and the solid state drive 400 is not adversely affected.

During the flowchart as shown in FIG. 6B is performed or after the flowchart as shown in FIG. 6B is completed, the write data in the reserved area 496 may be optionally deleted. Consequently, the writable capacity of the reserved area 496 will be enhanced.

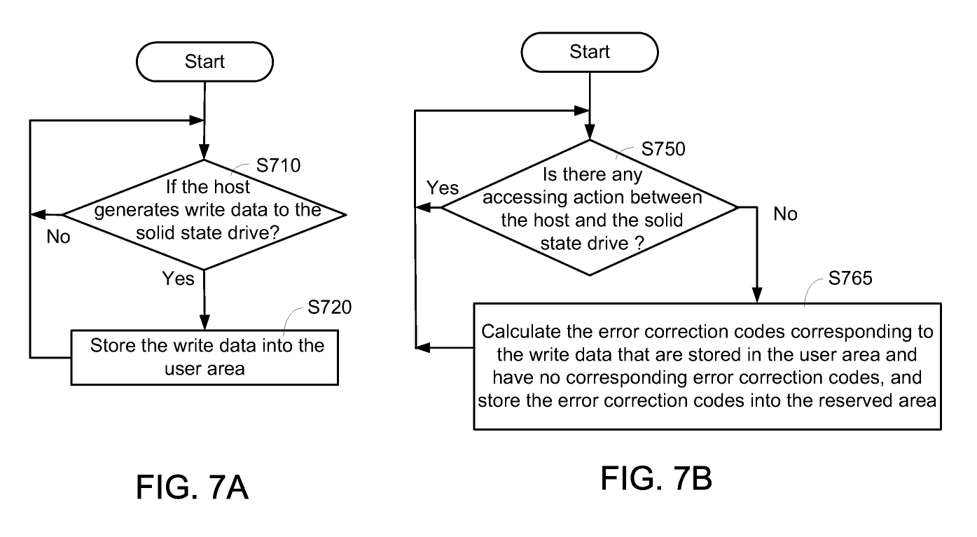

FIGS. 7A and 7B are flowcharts illustrating a data storing method using a DIE RAID technique according to the third embodiment of the present invention. Please refer to FIG. 7A. After the solid state drive 400 is activated, the solid state drive 400 continuously waits for the write command and the write data from the host. If the host generates write data to the solid state drive 400 (Step S710), the write data are stored into the user area 494 by the controlling unit 492 (Step S720).

Please refer to FIG. 7B, which illustrates a way of moving data when there is not accessing action between the host and the solid state drive 400. After the solid state drive 400 is activated, the controlling unit 492 will judge whether any accessing action between the host and the solid state drive 400 is done or not (Step S750). If the controlling unit 492 confirms that there is not accessing action between the host and the solid state drive 400, the solid state drive 400 starts to perform a background operation.

Consequently, the error correction codes corresponding to the write data that are stored in the user area 494, which have no corresponding error correction codes, are calculated by the error correction unit 493, and then stored into the reserved area 496 (Step S765).

From the above discussion, if there is no accessing action between the host and the solid state drive 400, the controlling unit 492 will perform a background operation. During the background operation is performed, the write data having no corresponding error correction codes are calculated to generate corresponding error correction codes. The error correction codes are then stored in the reserved area 496.

In the above three embodiments, the present invention provides a data storing method for a solid state drive. When there is no accessing action between the host and the solid state drive 400, the controlling unit 492 performs a background operation and stores the error correction codes into the reserved area 496. In such way, the speed of writing data and the data accuracy are both enhanced. Hereinafter, a process of storing the writing data into the solid state drive will be illustrated by referring to the data storing method according to the second embodiment of present invention.

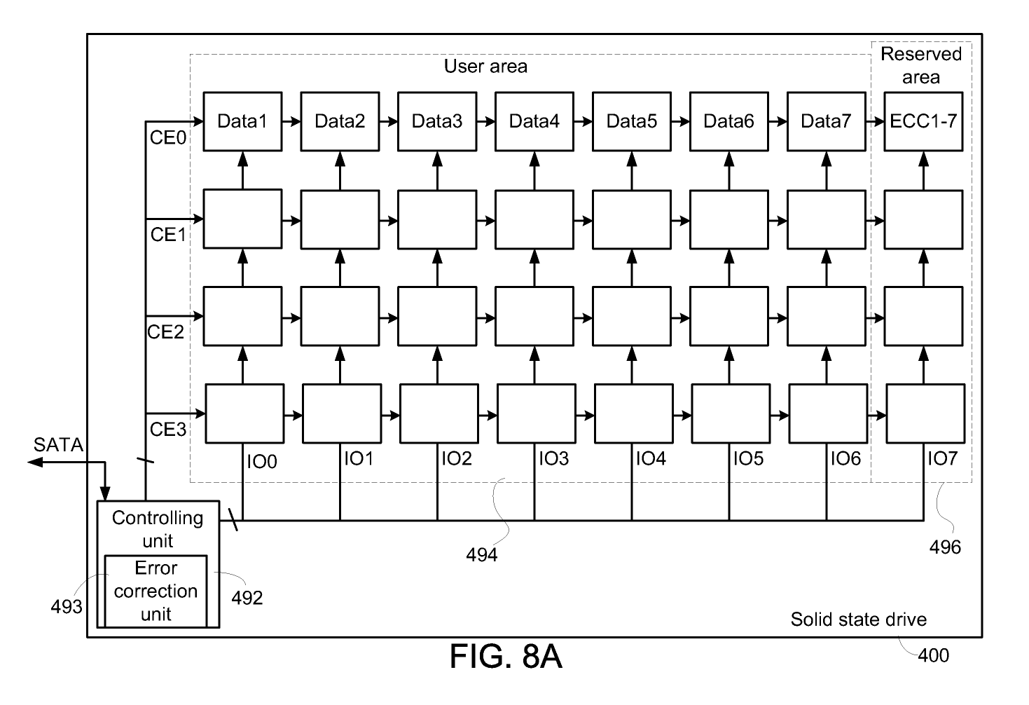

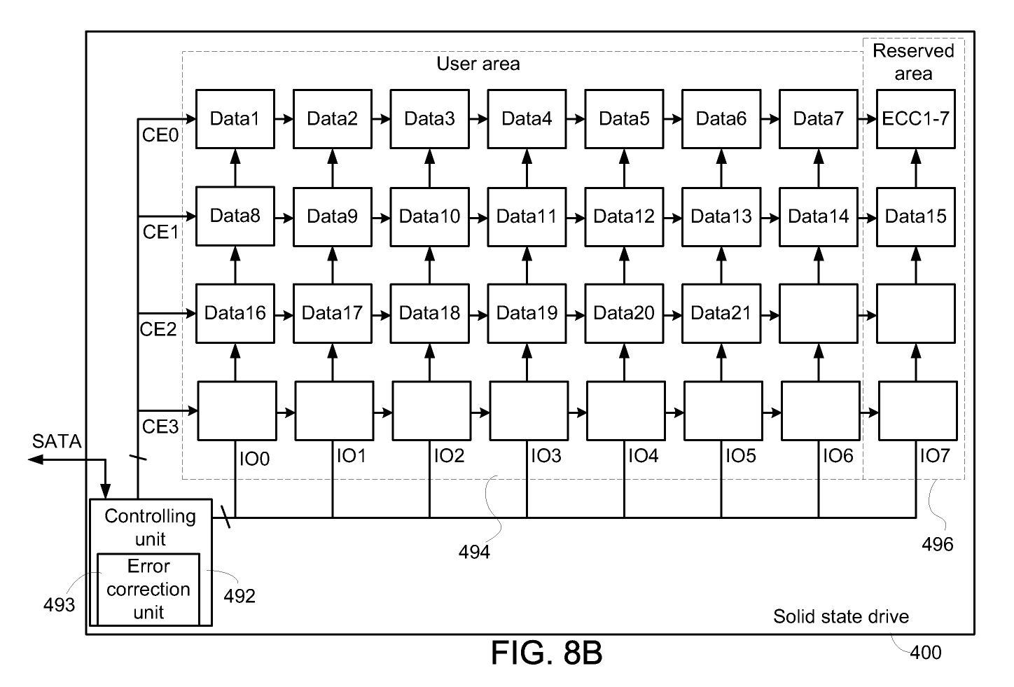

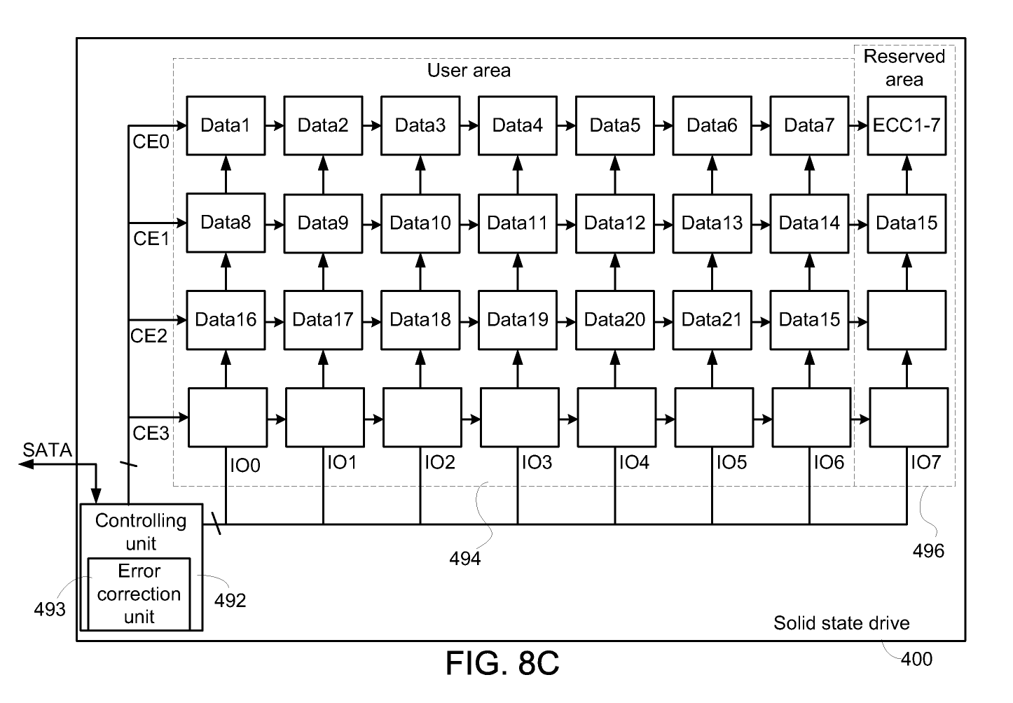

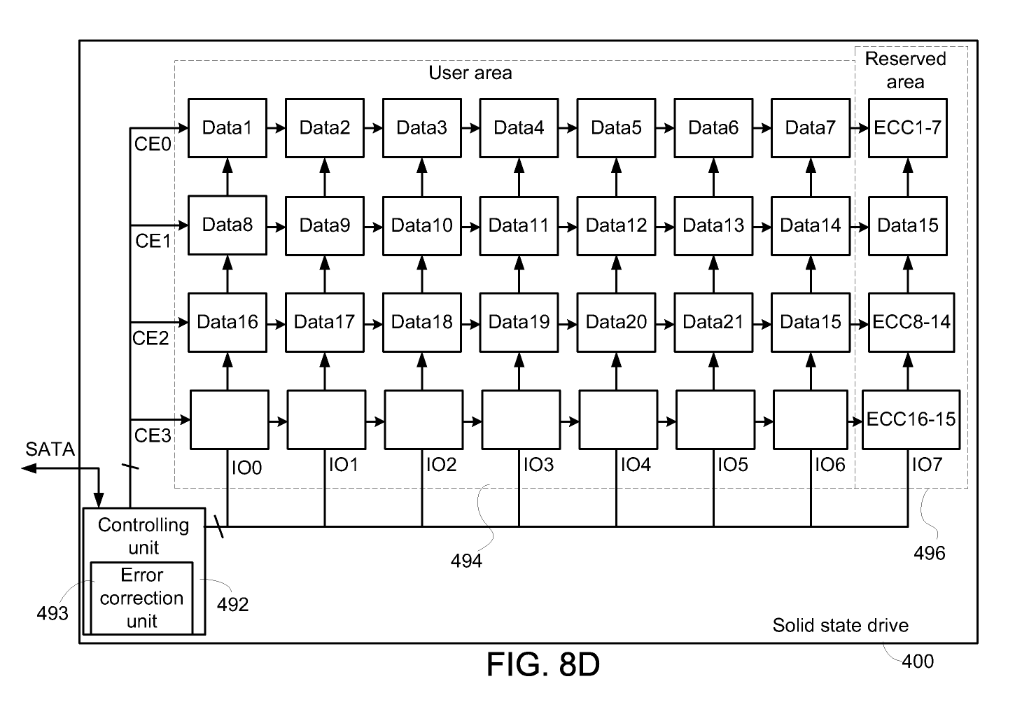

FIGS. 8A˜8D schematically illustrate the process of storing the writing data into the solid state drive by the data storing method according to the second embodiment of present invention. In the drawings, the blank die is writable. As shown in FIG. 8A, the user area 494 of the solid state drive 400 has stored the data Data1˜Data7. In addition, corresponding error correction codes ECC1˜7 are stored in the reserved area 496.

As shown in FIG. 8B, the host generate the write data Data8˜Data21. These write data are stored in not only the user area 494 but also the reserved area 496. Meanwhile, the corresponding error correction codes of these write data Data8˜Data21 have not been calculated by the error correction unit 493 of the controlling unit 492. Moreover, the write data Data15 is stored in the reserved area 496.

If there is accessing action between the host and the solid state drive 400, the controlling unit 492 performs a background operation. Moreover, the write data Data15 in the reserved area 496 is copied and stored into the user area 494 (see FIG. 8C).

Then, as shown in FIG. 8D, the error correction codes ECC8˜14 of the write data Data8˜Data14 is calculated by the error correction unit 493 and recorded into the reserved area 496. Moreover, the error correction codes ECC16˜15 of the write data Data16˜Data21 and Data15 are calculated by the error correction unit 493 and stored into the reserved area 496.

After the write date Data15 in the reserved area 496 is stored in the reserved area 496, the write date Data15 in the reserved area 496 becomes an invalid data. For increasing the writable capability of the reserved area 496, the write date Data15 in the reserved area 496 will be deleted at a proper time spot.

From the above description, the present invention provides a data storing method for a solid state drive. During the background operation is performed, the error correction codes are generated and written into the reserved area 496. Consequently, the speed of writing data and the data accuracy are both enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data storing method for a solid state drive, the solid state drive comprising a plurality of dies, the dies being divided into first-portion dies and second-portion dies, the first-portion dies being located at a user area, the second-portion dies being located at a reserved area, the solid state drive being in communication with a host, the data storing method comprising steps of:
if the host generates a plurality of write data to the solid state drive, storing the write data into the reserved area;
if there is no accessing action between the host and the solid state drive, judging whether the plurality of write data are in the reserved area;
if the plurality of write data are in the reserved area, storing the write data into the user area; and
calculating error correction codes corresponding to the write data in the user area, and storing the error correction codes into the reserved area.

2. The data storing method as claimed in claim 1, further comprising a step of deleting the write data that are stored in the reserved area.

3. A data storing method for a solid state drive, the solid state drive comprising a plurality of dies, the dies being divided into first-portion dies and second-portion dies, the first-portion dies being located at a user area, the second-portion dies being located at a reserved area, the solid state drive being in communication with a host, the data storing method comprising steps of:
if the host generates a plurality of write data to the solid state drive, storing the write data into the user area and the reserved area;
if there is no accessing action between the host and the solid state drive , judging whether a portion of the write data are in the reserved area;
if the portion of the write data in the reserved area, storing the portion of the write data into the user area; and
calculating error correction codes corresponding to the write data in the user area, and storing the error correction codes into the reserved area.

4. The data storing method as claimed in claim 3, further comprising a step of deleting the portion of the write data that are stored in the reserved area.

5. A data storing method for a solid state drive, the solid state drive comprising a plurality of dies, the dies being divided into first-portion dies and second-portion dies, the first-portion dies being located at a user area, the second-portion dies being located at a reserved area, the solid state drive being in communication with a host, the data storing method comprising steps of:
if the host generates a plurality of write data to the solid state drive, storing the write data into the user area; and
if there is no accessing action between the host and the solid state drive, calculating error correction codes corresponding to the write data in the user area, and storing the error correction codes into the reserved area.

6. A solid state drive in communication with a host, the solid state drive comprising:
a controlling unit in communication with the host through a specified bus, wherein the controlling unit comprises an error correction unit; and
a plurality of dies connected with the controlling unit, wherein the dies are divided into first-portion dies and second-portion dies, the first-portion dies are located at a user area, and the second-portion dies are located at a reserved area,
wherein if the host generates a plurality of write data to the solid state drive, the write data are stored into the user area or the reserved area by the controlling unit, wherein if there is not accessing action between the host and the solid state drive, error correction codes corresponding to the write data are calculated by the controlling unit and stored into the reserved area.

7. The solid state drive as claimed in claim 6, wherein the specified bus is a SATA bus or a USB bus.
